(19) United States
(12) Patent Application Publication
(10) Pub. No.: US 2025/0156823 A1
(43) Pub. Date: May 15, 2025

(54) SYSTEMS AND METHODS FOR PERSONALIZING A MERCHANT IDENTIFIER

(71) Applicant: Wells Fargo Bank, N.A., San Francisco, CA (US)

(72) Inventors: Michelle E. Ziolkowski, Pittsburgh, PA (US); Erin Aine Croll, Des Moines, IA (US)

(21) Appl. No.: 18/506,763

(22) Filed: Nov. 10, 2023

(51) Int. Cl. G06Q 20/06; G06Q 20/32; G06Q 30/0204

(52) U.S. Cl. CPC G06Q 20/06; G06Q 20/322; G06Q 30/0205

(57) ABSTRACT

Systems, apparatuses, methods, and computer program products are disclosed for a personalized merchant identifier. An example method includes receiving, by communications hardware, a set of transaction data elements, wherein the set of transaction data elements include an indication of a payment type or a merchant and deriving, by a personalization engine, a set of merchant data elements from the set of transaction data elements. The example method further includes receiving, by the communications hardware and from a user, one or more payment accessibility parameters and comparing, by the personalization engine, the one or more payment accessibility parameters to the set of merchant data elements to identify one or more compliant merchants, wherein the one or more compliant merchants comply with the one or more payment accessibility parameters. The example method further includes performing, by a notification circuitry and based on the one or more compliant merchants, an action.

### BACKGROUND

Personalizing a customer's experience requires gathering data about the customer and data about the customer experiences. However, it has traditionally been challenging to scale personalization of customer experience without human involvement.

### BRIEF SUMMARY

Personalizing customer experience is beneficial to both an entity and to its customers. Effective personalization often makes customers feel more valued, which inspires greater loyalty to (and repeat engagement with) the entity. One area in need of greater personalization is the matching of merchants and customers based on location and payment options.

Legacy approaches for identifying merchant suitability amount to the provision of static guidance. For example, a customer may report one or more relevant parameters to an entity, such as a particular location, payment type, and/or the like, associated with a particular merchant, while a particular merchant may report to the entity one or more parameters that describe data (e.g., location data, payment type data, and/or the like) about themselves (e.g., the particular merchant), and the reported data may later be used to identify one or more particular merchants for a customer.

However, aged data about a particular merchant may affect an entity's ability to personalize merchant identification for an individual (e.g., a customer). For example, assume the entity has historical data that indicates that a merchant accepts cash, card, and contactless payment options. If the merchant's contactless payment device is suddenly under maintenance for two days, the aged data that describes that the particular merchant accepts contactless payment options may result in poor personalized merchant identification for an individual who only has a smartphone available and is expecting to use a contactless payment option. As a result, historical solutions may periodically push notifications to a merchant to report particular parameters that may be used to personalize identification of merchants for an individual. Nonetheless, it may not be reliable to depend solely on merchants to report an event that may result in inaccurate personalized merchant identification. For instance, in the above example where a merchant's contactless payment device is under maintenance for two days, the merchant may inadvertently ignore the received notification. More sophisticated personalization is thus necessary, and such personalization has historically only been possible through manual interaction with a customer and/or a merchant.

Example embodiments described herein mitigate the above concerns by creating and using a centralized system that in near-real-time collects both customer data and merchant data (e.g., transaction data) and then delivers personalized recommendations identifying suitable merchants for an individual (e.g., a customer). To do so, some example embodiments may receive a set of transaction data elements. The set of transaction data elements may describe the particular payment type, a particular merchant, location data, and/or the like associated with one or more transactions. Example embodiments may then derive a set of merchant data elements from the set of transaction data elements. The set of merchant data elements may describe parameters associated with a particular merchant. In some embodiments, the set of merchant data elements may be based on trends derived from the transaction data elements. For example, if the set of transaction data elements describes the location of a particular merchant (e.g., a food truck) in a multiple locations, the set of merchant data elements may describe the particular merchant's location as “unstable,” “variable,” or the like.

Example embodiments may also receive from a user (e.g., a customer) one or more payment accessibility parameters. The payment accessibility parameters may configure the system to identify particular merchants for a particular user. In some embodiments, the payment accessibility parameters may identify criteria of interest via geofence parameters. The geofence parameters may be used to push notifications to a user upon violation of the geofence parameters for a geofenced area of interest. For example, assume the geofence parameters describe that a user prefers contactless payment options. As a result, the geofence parameters may cause the system to evaluate a geofenced region and detect whether the geofence parameters are violated, in which case the system may transmit a geofence personalized payment notification to the user.

Example embodiments may also compare the merchant locations and payment accessibility parameters to the set of merchant data elements to identify one or more compliant merchants. In some embodiments, the one or more compliant merchants comply with at least one of the payment accessibility parameters. Example embodiments may also perform an action based on the one or more identified compliant merchants. In some embodiments, the action may include generating and causing presentation of a personalized payment graphic that illustrates the one or more compliant merchants.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for personalizing a merchant identifier, in accordance with some example embodiments described herein.

FIG. 4 illustrates an example flowchart for identifying a payment trend that may indicate a payment deviation, in accordance with some example embodiments described herein.

FIG. 5 illustrates an example flowchart for determining and using a merchant trend parameter to identify a payment trend, in accordance with some example embodiments described herein.

FIG. 6 illustrates an example flowchart for using a supplemental payment device to complete a transaction, in accordance with some example embodiments described herein.

FIG. 7 illustrates an example flowchart for using a geofence to perform an action, in accordance with some example embodiments described herein.

FIG. 8 illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “geofence” refers to a virtual geographic boundary. A geofence may be defined by global positioning system (GPS) technology, radio frequency identification (RFID) technology, and/or the like. In some embodiments, software on a computing device may use GPS, RFID, or the like, to identify and trigger an action when the computing device enters or exits a geofence.

### System Architecture

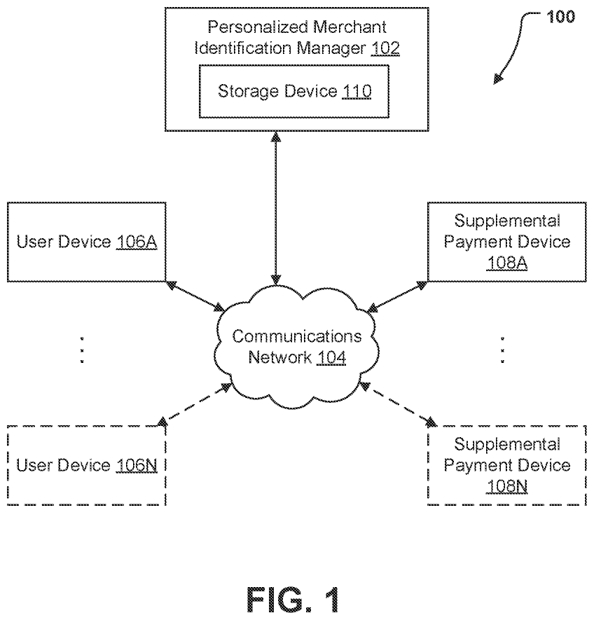

Example embodiments described herein may be implemented using any of a variety of computing devices or servers. To this end, FIG. 1 illustrates an example environment 100 within which various embodiments may operate. As illustrated, a personalized merchant identification manager 102 may receive and/or transmit information via communications network 104 (e.g., the Internet) with any number of other devices, such as one or more of user devices 106A-106N and/or supplemental payment devices 108A-108N.

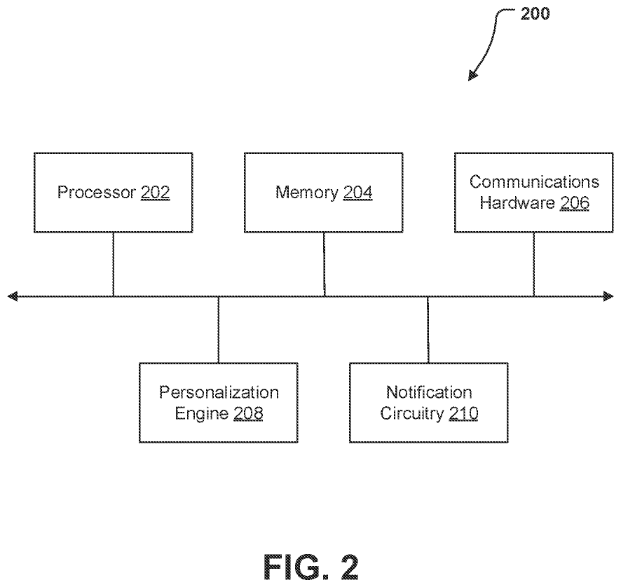

The personalized merchant identification manager 102 may be implemented as one or more computing devices or servers, which may be composed of a series of components. Particular components of the personalized merchant identification manager 102 are described in greater detail below with reference to apparatus 200 in connection with FIG. 2.

In some embodiments, the personalized merchant identification manager 102 further includes a storage device 110 that comprises a distinct component from other components of the personalized merchant identification manager 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the personalized merchant identification manager 102. Storage device 110 may store information relied upon during operation of the personalized merchant identification manager 102, such as various algorithms that may be used by the personalized merchant identification manager 102, data and documents to be analyzed using the personalized merchant identification manager 102, or the like. In addition, storage device 110 may store control signals, device characteristics, and access credentials enabling interaction between the personalized merchant identification managerl02 and one or more of the user devices 106A-106N or supplemental payment devices 108A-108N.

The one or more user devices 106A-106N and the one or more supplemental payment devices 108A-108N may be embodied by any computing devices known in the art such as desktop or laptop computers, smartphones, smart devices, internet of things (IoT) devices, or the like. The one or more user devices 106A-106N may be associated with a particular individual (e.g., a customer) or particular merchant. The one or more supplemental payment devices 108A-108N may also include automated teller machines (ATMs), a Point-of-Sale terminal (POS) terminal of another merchant (e.g., a transaction between a user and merchant A via a POS terminal associated with merchant B), or the like. The one or more user devices 106A-106N and the one or more supplemental payment devices 108A-108N need not themselves be independent devices, but may be peripheral devices communicatively coupled to other computing devices.

### Example Implementing Apparatuses

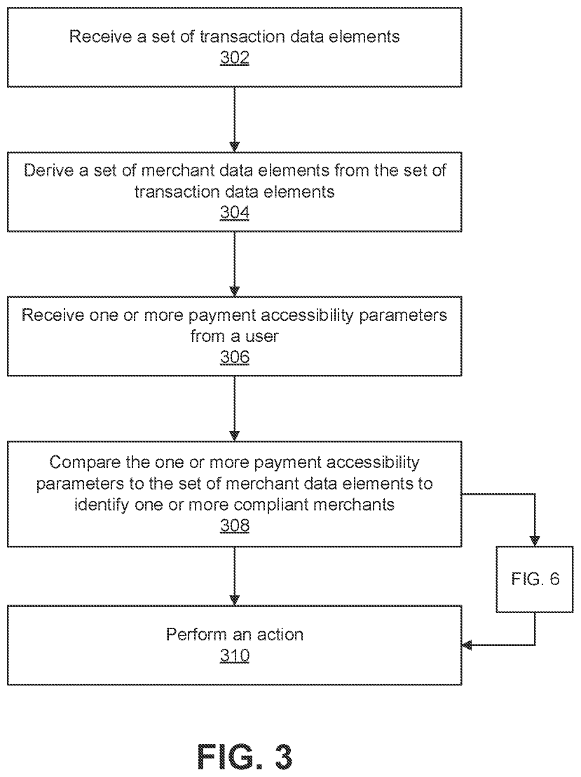

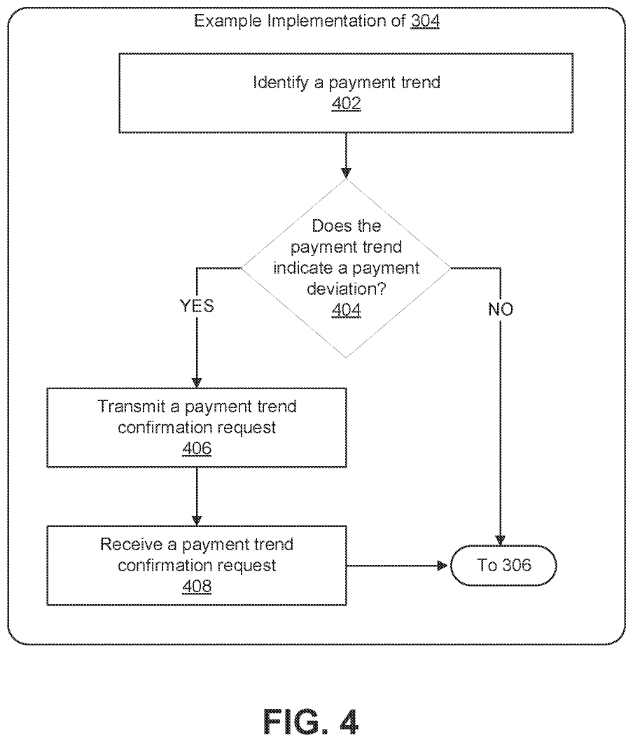

The personalized merchant identification manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-4. As illustrated in FIG. 2, the apparatus 200 may include processor 202, memory 204, communications hardware 206, personalization engine 208, and notification circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor 202 may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a personalization engine 208 that derives a set of merchant data elements from the set of transaction data elements. The personalization engine 208 may also compare the one or more payment accessibility parameters to the set of merchant data elements to identify one or more compliant merchants. The personalization engine 208 may utilize processor 202, memory 204, or any other hardware component included in the apparatus 200 to perform these operations, as described in connection with FIGS. 3-7 below. The personalization engine 208 may further utilize communications hardware 206 to gather data from a variety of sources (e.g., supplemental payment device 108A through supplemental payment device 108N or storage device 110, as shown in FIG. 1), and/or exchange data with a user, and in some embodiments may utilize processor 202 and/or memory 204 to perform any or more of the above operations.

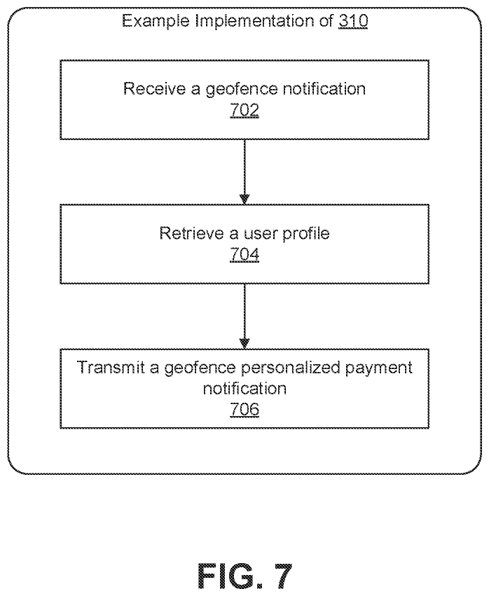

In addition, the apparatus 200 further comprises a notification circuitry 210 that performs an action based on the evaluation of merchant compliance with customer requirements. In particular, the notification circuitry 210 may generate a personalized payment graphic and cause a computing device associated with a user (e.g., user device 106A, or the like) to present the personalized payment graphic to the user. The notification circuitry 210 may utilize processor 202, memory 204, or any other hardware component included in the apparatus 200 to perform these operations, as described in connection with FIG. 3 and FIG. 7 below. The notification circuitry 210 may further utilize communications hardware 206 to gather data from a variety of sources (e.g., supplemental payment device 108A-108N or storage device 110, as shown in FIG. 1), and/or exchange data with a user, and in some embodiments may utilize processor 202 and/or memory 204 to perform any or more of the above operations.

Although components 202-210 are described in part using functional language, it will be understood that the particular implementations necessarily include the use of particular hardware. It should also be understood that certain of these components 202-210 may include similar or common hardware. For example, the personalization engine 208 and notification circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus 200 therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the personalization engine 208 and notification circuitry 210 may leverage processor 202, memory 204, or communications hardware 206 as described above, it will be understood that any of personalization engine 208 and notification circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that personalization engine 208 and notification circuitry 210 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

Turning to FIGS. 3-7, example flowcharts are illustrated that contain example operations implemented by example embodiments described herein. The operations illustrated in FIGS. 3-7 may, for example, be performed by the personalized merchant identification manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, personalization engine 208, notification circuitry 210, and/or any combination thereof. It will be understood that user interaction with the personalized merchant identification manager 102 may occur directly via communications hardware 206, or may instead be facilitated by a separate user device 106A-106N, as shown in FIG. 1, and which may have similar or equivalent physical componentry facilitating such user interaction.

Turning first to FIG. 3, example operations are shown for a personalized merchant identifier.

As shown by operation 302, the apparatus 200 includes means, such as memory 204, communications hardware 206, or the like, for receiving a set of transaction data elements. The set of transaction data elements may include one or more data elements that describe a particular transaction, such as location data, an indication of the payment type (e.g., card swipe, contactless payment, or the like), the date and time associated with the particular transaction, the transaction amount, an indication of the particular merchant, an indication of the customer (e.g., a user identifier), the computing device used to complete the transaction, and/or the like. In some embodiments, the set of transaction data elements may include data from a plurality of transactions. For example, the set of transaction data elements may include location data, an indication of the payment type, the date and time, an indication of the merchant, the transaction amount, a user identifier, the computing device used to complete the transaction, and/or the like corresponding to a transaction A, a transaction B, and a transaction C.

In some embodiments, communications hardware 206 may receive the set of transaction data elements from a computing device associated with a user (e.g., user device 106A, or the like) via a network (e.g., communications network 104, shown in FIG. 1) and the apparatus 200 (e.g., communications hardware 206) may subsequently store the set of transaction data elements in a local storage device (e.g., memory 204, storage device 110, or the like). In some embodiments, the user associated with the computing device may be a customer (e.g., an individual who initiates a transaction) or a merchant (e.g., a vendor who is the counterparty in a transaction). As such, the set of transaction data elements may be received from either party or both parties involved in a transaction, thereby enabling communications hardware 206 to receive a variety of data that may not be available if the set of transaction data elements were merely received from one perspective. For example, acquiring the data necessary to determine both a customer's individual transaction tendencies (e.g., a preferred payment type, or the like) and information about a merchant (e.g., foot traffic, customer dwelling time, inventory, or the like) and then subsequently using the data (e.g., a set of transaction data elements) acquired from both customers and merchants to provide personalized identification of merchants for a customer would not be possible without access to data from both parties involved in a transaction.

In some embodiments, communications hardware 206 may receive the set of transaction data elements in response to the occurrence of an automatic trigger event. An automatic trigger event may include a temporal trigger event, a circumstantial trigger event, and/or the like. A temporal trigger event may take place based on rules and/or configurations predefined by a user (e.g., a customer, merchant, or the like) or entity (e.g., a financial institution that is providing the personalized merchant identifier) that requires a computing device associated with the user (e.g., user device 106A, user device 106N, or the like) to transmit the set of transaction data elements within a particular time period or at a particular point in time. For example, the apparatus 200 (e.g., notification circuitry 210) may configure a temporal trigger that causes a computing device associated with a particular merchant (e.g., user device 106A) to periodically (e.g., at the end of each business day) transmit a set of transaction data elements via network (e.g., communications network 104, shown in FIG. 1) to the communications hardware 206.

A circumstantial trigger event may take place based on rules and/or configurations predefined by a user (e.g., a customer, merchant, or the like) or entity (e.g., a financial institution that is providing the personalized merchant identifier) that requires the transmission of the set of transaction data elements from a computing device associated with the user to the apparatus 200 (e.g., communications hardware 206) upon occurrence of a particular event. For example, notification circuitry 210 may configure a circumstantial trigger that causes a computing device associated with a customer (e.g., user device 106N) to transmit a set of transaction data elements to communications hardware 206 via a network (e.g., communications network 104, shown in FIG. 1) if the customer makes a transaction at a restaurant.

As shown by operation 304, the apparatus 200 includes means, such as, memory 204, communications hardware 206, personalization engine 208, or the like, for deriving a set of merchant data elements from the set of transaction data elements. The set of merchant data elements may include data elements that describe a particular merchant, such as accepted payment types, foot traffic, customer dwelling times, a probable location, and/or the like. In some embodiments, the set of merchant data elements may include data associated with a plurality of merchants. For example, the set of merchant data elements may include location data, an indication of the accepted payment types, and/or the like, corresponding to each of a merchant A, merchant B, and merchant C.

In some embodiments, personalization engine 208 may derive the set of merchant data elements from the set of transaction data elements received in operation 304. For example, personalization engine 208 may use one or more techniques to identify data elements included in the set of transaction data elements that are associated with a particular merchant. To this end, personalization engine 208 may use optical character recognition (OCR), natural language processing (NLP), searching algorithms, and/or the like, to identify and sort the set of transaction data elements into the set of merchant data elements.

In some embodiments, personalization engine 208 may leverage a model to identify trends in the set of merchant data elements in near real-time that would otherwise be difficult to identify due to the copious amounts of merchant data elements and/or sets of merchant data elements associated with popular merchants. For example, personalization engine 208 may leverage an unsupervised machine learning model to cluster the set of merchant data elements. In some embodiments, the unsupervised machine learning model may be trained to perform a particular clustering method (e.g., k-means clustering, or the like). In some embodiments, if the unsupervised machine learning model is trained to use a k-means clustering technique, the training for the unsupervised machine learning model may include utilizing a training technique (e.g., the elbow method, silhouette method, and/or the like) to determine the optimal k value based on the input set of merchant data elements.

In some embodiments, personalization engine 208 may input the set of merchant data elements and select features associated with the merchant data elements, such as the accepted payment types and time stamps, into the unsupervised machine learning model. The unsupervised machine learning model may cluster the set of merchant data elements based on their similarity (e.g., similar accepted payment types). For example, assume the unsupervised model created three clusters from the set of merchant data elements. Cluster 1 may include transactions that were completed using a contactless payment option during weekdays, cluster 2 may include transactions that were completed without using a contactless payment option (e.g., card swipes, cash, or the like) on weekends, and cluster 3 may include a mix of payment types regardless of the day of the week. Subsequently, the unsupervised machine learning model may output the results to a local storage device (e.g., memory 204, storage device 110, or the like) and/or directly communicate the results to personalization engine 208. As a result, personalization engine 208 may retrieve the results from a local storage device, if needed, and subsequently derive a set of merchant data elements (e.g., merchant data elements associated with the payment types for a particular merchant and how that payment type varies depending on the day of the week) from the model results.

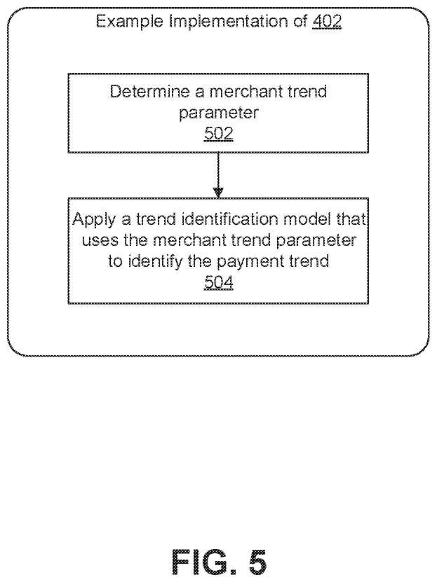

Additionally or alternatively, personalization engine 208 may leverage a supervised machine learning model to identify trends, such as a payment trend. Some example implementations for identifying a payment trend are described further below in relation to FIG. 4 and FIG. 5. Turning now to FIG. 4, example operations are shown for identifying a payment trend.

As shown by operation 402, the apparatus 200 includes means, such as memory 204, personalization engine 208, or the like, for identifying a payment trend. A payment trend may predict the accepted payment type(s) associated with a particular merchant. To this end, the set of merchant data elements may include data about historical transactions, such as a historical transaction amount(s), a time stamp of the transaction(s), and the accepted payment type(s). In some embodiments, personalization engine 208 may input the set of merchant data elements into the supervised machine learning model described above in relation to operation 304. The supervised machine learning model may use a classification algorithm, such as logistic regression, support vector machines, and/or the like, to identify a payment trend among the set of merchant data elements. For example, assume the supervised machine learning model is given a set of merchant data elements and is trained to classify historical data based on the accepted payment type (e.g., contactless payments accepted or contactless payments not accepted). The supervised machine learning model may then select a logistic regression algorithm to identify a decision boundary that separates the transactions associated with particular merchant data elements. For example, the location of a particular transaction with respect to the determined decision boundary may indicate a specific payment type. Personalization engine 208 may receive the result of the logistic regression algorithm from a local storage device (e.g., memory 204, storage device 110, or the like) or directly from the supervised machine learning model and subsequently use the result to predict a payment trend for a particular merchant.

In some embodiments, personalization engine 208 may use a model to perform a time series analysis on the set of merchant data elements and a historical set of merchant data elements (e.g., previously received set of merchant data elements stored in a local storage device, such as memory 204, storage device 110, or the like) to identify a payment trend. For example, personalization engine 208 may leverage a model to calculate the percentage of transactions where contactless payment transactions at a particular merchant were accepted and/or where contactless payment transactions at a particular merchant were not accepted, and based on the calculated percentages, determine a payment trend. In some embodiments, personalization engine 208 may use a payment trend threshold (e.g., a threshold predetermined from historical analysis of payment trends derived from a set of historical merchant data elements) to determine a payment trend. For example, the payment trend threshold may determine that if 70% or more of the transactions associated with a particular merchant are of a particular payment type, personalization engine 208 may identify the particular payment type as a payment trend. In some embodiments, the payment trend threshold and/or the model used for the time series analysis may also account for the recency of the historical set of merchant data elements (e.g., by referencing a time stamp included in the historical set of merchant data elements). For example, the model may dynamically weight merchant data elements included in the historical set of merchant data elements based on the date (e.g., a time stamp) associated with the merchant data elements. As a result, the model and/or personalization engine 208 may include information about the recency of the merchant data elements while calculating a percentage that may be used to later compare to a threshold to identify a payment trend.

In some embodiments, the apparatus 200 (e.g., communications hardware 206) may receive an electronic notification from a user (e.g., a merchant) indicating a preference for how to weight particular trends, such as payment trends, location trends, and/or the like. For example, communications hardware 206 may receive an electronic notification from a computing device associated with a merchant (e.g., user device 106A, or the like) via a network (e.g., communications network 104, shown in FIG. 1). By means of continuing example, communications hardware 206 may leverage personalization engine 208 to identify the request included in the electronic notification. For instance, personalization engine 208 may use optical character recognition (OCR), natural language processing (NLP), searching algorithms, and/or the like to identify the request included in the electronic notification. For example, personalization engine 208 may OCR any data in the received electronic notification, if needed, and then search for an indicator of a particular request. As such, personalization engine 208 may search for the terms “location,” “accepted payment type,” or the like, which may act as an identifier to identify the request.

To this end, in order for the apparatus 200 to provide live updates in response to received electronic notifications and constantly received sets of transaction data elements (and hence constantly deriving sets of merchant data elements), personalization engine 208 may continuously update the weights associated with the models described above to provide a near real-time identification of trends (e.g., payment type trends, location trends, or the like) that align with user preferences (e.g., user preferences derived from user transmitted electronic notifications). For example, personalization engine 208 may be configured to automatically input the received set of merchant data elements for a particular merchant into a model (e.g., a supervised machine learning model, unsupervised machine learning model, or the like).

Additionally or alternatively, the apparatus 200 (e.g., personalization engine 208) may automatically determine weights for the models described above (e.g., without or in combination with received electronic notifications from a user). For example, assume personalization engine 208 identifies, by performing a time series analysis technique on the set of merchant data elements associated with a particular merchant, that the particular merchant's location is not stable (e.g., a food truck that is constantly changing locations). In this regard, personalization engine 208 may search a storage device (e.g., memory 204, storage device 110, or the like) for a set of trend identification rules. The trend identification rules may describe one or more rules and/or configurations predefined by a user or entity (e.g., a financial institution that provides the personalized merchant identifier) that may be used to automatically determine trends in the set of merchant data elements. By continuing the above example where a merchant's location is not stable, personalization engine 208 may identify that if a location for a merchant is variable more than 50% of the time, to identify the merchant's location as unstable. The trend identification rules may also include instructions for how to derive the set of merchant data elements from received transaction data elements when particular rules and/or configurations are satisfied, such as heavily weighing the most recent location data when deriving the location of a particular merchant that is identified to have an unstable location.

In some embodiments, the apparatus 200 (e.g., payment engine 208) may determine a merchant trend parameter to aid in the identification of trends, such as a payment trend, in the set of merchant data elements. Determining and using the merchant trend parameter are described further below in relation to FIG. 5. Turning now to FIG. 5, example operations are shown for determining and using a merchant trend parameter to identify trends (e.g., a payment trend) in the set of merchant data elements.

As shown by operation 502, the apparatus 200 includes means, such as memory 204, personalization engine 208, or the like, for determining a merchant trend parameter. The merchant trend parameter may be based on the set of merchant data elements associated with a particular merchant. In some embodiments, personalization engine 208 may reference a set of merchant trend parameter rules stored in a local storage device (e.g., memory 204, storage device 110, and/or the like) that describes thresholds that when satisfied trigger personalization engine 208 to determine a merchant trend parameter. For example, assume a particular merchant (e.g., a food truck) has a highly variable location, which is evident in the set of merchant data elements associated with the particular merchant (e.g., the merchant data elements included in the set of merchant data elements may frequently indicate different locations). Continuing the example, personalization engine 208 may reference the set of merchant trend parameter rules in memory 204 to identify a particular merchant trend parameter rule associated with variable location data, such as a particular merchant trend parameter that is associated with a merchant that changes their location every day. As a result, personalization engine 208 may determine based on the merchant trend parameter rule associated with variable location data, a merchant trend parameter.

As shown by operation 504, the apparatus 200 includes means, such as memory 204, communications hardware 206, personalization engine 208, or the like, for applying a trend identification model. In some embodiments, the trend identification model uses the merchant trend parameter to identify the payment trend. In some embodiments, the merchant trend parameter may be input into the trend identification model. As a result, personalization engine 208 may apply the trend identification model that uses the merchant trend parameter to determine a trend, such as a payment trend, location trend, and/or the like. By continuing the above example where a merchant trend parameter was determined for a particular merchant with highly variable location data, that merchant trend parameter may be input into a trend identification model and may instruct the trend identification model. As a result, the trend identification model may then reference the merchant trend parameter to optimize trend identification for that particular merchant (e.g., a food truck). As such, the trend identification model may be configured to update its weights based on a particular input merchant trend parameter. For instance, in the above example where the merchant trend parameter is associated with a variable location, following personalization engine 208 inputting the merchant trend parameter into the trend identification model, the trend identification model may update its weights to prioritize recent location data included in the set of merchant data elements.

Returning to FIG. 4, as shown by operation 404, the apparatus 200 includes means, such as memory 204, personalization engine 208, or the like, for determining if the payment trend indicates a payment deviation. To do so, personalization engine 208 may reference a set of payment deviation rules stored in a local storage device (e.g., memory 204, storage device 110, or the like) that describe rules and/or conditions that when satisfied trigger the personalization engine 208 to identify a payment deviation. For example, assume a merchant traditionally only accepts contactless payment options. If a set of merchant data elements associated with the merchant suddenly indicates that the merchant accepts cash, personalization engine 208 may search the payment deviation rules to search for a rule that describes the percentage of merchant data elements included in the set of merchant data elements that are required to indicate a new payment type in order for personalization engine 208 to determine a payment deviation. In this regard, personalization engine 208 may retrieve the set of merchant data elements from a local storage device to determine the percentage of the transaction data elements of a particular date range that indicate the new payment type and subsequently compare the percentage to the set of payment deviation rules to determine a payment deviation.

In some embodiments, personalization engine 208 may determine a payment deviation. In such an embodiment, the procedure may advance to operation 406. However, if personalization engine 208 does not determine a payment trend deviation, the procedure may skip operations 406 and 408 and proceed to operation 306.

As shown by operation 406, the apparatus 200 includes means, such as memory 204, communications hardware 206, or the like, for transmitting a payment trend confirmation request. The payment trend confirmation request may be an electronic request transmitted from the apparatus 200 (e.g., communications hardware 206) via network (e.g., communications network 104, shown in FIG. 1) to a computing device associated with a user (e.g., user device 106A, or the like) that requests the user (e.g., a customer, merchant, or the like) to confirm or reject the payment deviation in response to operation 404 yielding a result that indicates a determined payment deviation. For example, assume a payment deviation was identified for a particular merchant. Communications hardware 206 may transmit the payment trend confirmation request to a user device (e.g., user device 106A) associated with the particular merchant (e.g., communications hardware 206 may retrieve a device ID for a computing device associated with the particular merchant from a local storage device, such as memory 204, storage device 110, or the like).

In some embodiments, the apparatus 200 (e.g., communications hardware 206) may transmit additional trend confirmation requests in addition to the payment trend confirmation request (e.g., a location deviation request). For example, if a deviation is identified and indicates a merchant's location has changed, an additional trend confirmation request, such as a location trend confirmation request, may be transmitted to the merchant associated with the deviated location that requests the merchant to confirm or reject the identified deviation in the merchant's location.

As shown by operation 408, the apparatus 200 includes means, such as memory 204, communications hardware 206, personalization engine 208, or the like, for receiving the payment trend confirmation request. In some embodiments, communications hardware 206 may receive the payment trend confirmation request from a computing device (e.g., user device 106A, or the like) via a network (e.g., communications network 104, shown in FIG. 1). The received payment trend confirmation request may confirm or reject the payment deviation from the computing device associated with the user that received the payment trend confirmation request. In some embodiments, communications hardware 206 may store the completed payment trend confirmation request in a local storage device (e.g., memory 204, storage device 110, or the like). In some embodiments, personalization engine 208 may then use one or more techniques, such as optical character recognition (OCR), natural language processing (NLP), searching algorithms, and/or the like to identify the status of the deviated payment trend (e.g., a confirmed payment trend or rejected payment trend) indicated by the user. For example, personalization engine 208 may OCR any data in the received completed payment trend confirmation request, if needed, and then search for an indicator of the status of the request. For instance, personalization engine 208 may search for the terms “confirmed”, “rejected”, or the like, which may act as an identifier to identify the status of the completed payment trend confirmation request.

Returning to FIG. 3, as shown by operation 306, the apparatus 200 includes means, such as memory 204, communications hardware 206, or the like, for receiving one or more payment accessibility parameters. The one or more payment accessibility parameters may describe particular rules and/or conditions defined by a user (e.g., a customer), which may be referenced to personalize identification of merchants for the user. For example, the received one or more payment accessibility parameters may describe a user identifier associated with the customer that transmitted the one or more payment accessibility parameters, the user's preferred payment type, and/or when a user wishes to identify merchants (e.g., periodically, only upon reception of a user request, automatically when entering a particular geographic region (e.g., a geofence), and/or the like).

In some embodiments, the received one or more payment accessibility parameters may indicate that a customer wishes to be automatically notified if they enter a geographic location (e.g., as defined by a geofence) that does not satisfy criteria predetermined by the customer or entity that provides the personalized merchant identifier. For example, a customer may request in the one or more payment accessibility parameters that if they enter a particular geographic region that includes a variety of merchants, and if a particular percentage (e.g., a predefined threshold) of the variety of merchants does not accept contactless payment options, to push an electronic notification (e.g., via communications hardware 206) to the computing device (e.g., user device 106A, or the like) associated with the customer, which may notify the customer that it may be unlikely to find a merchant that accepts their desired payment method (e.g., contactless payments). To this end, the apparatus 200 (e.g., notification circuitry 210, or the like) may continuously monitor the location of the computing device associated with the customer, such that when the customer enters a geofence that satisfies a condition included in the one or more payment accessibility parameters, the customer may then be notified via an electronic notification in near real-time.

In some embodiments, the one or more payment accessibility parameters may be received by the apparatus 200 (e.g., communications hardware 206) from a computing device associated with a customer (e.g., user device 106A) via a network (e.g., communications network 104, shown in FIG. 1). In some embodiments, communications hardware 206 may store the one or more payment accessibility parameters in a local storage device (e.g., memory 204, storage device 110, or the like). Additionally, communications hardware 206 may leverage personalization engine 208 or the like to use one or more techniques, such as optical character recognition (OCR), natural language processing (NLP), searching algorithms, and/or the like to identify any conditions (e.g., to only provide personalized identified merchants to the user in response to a received user request, or the like) imposed by the one or more payment accessibility parameters.

In some embodiments, the user (e.g., customer) associated with the one or more payment accessibility parameters may be identified via a user identifier included in the one or more payment accessibility parameters. As such, the apparatus 200 (e.g., personalization engine 208, or the like) may generate a user profile for the customer associated with the identified user identifier. The user profile may include the conditions included in the one or more payment accessibility parameters, the identified user identifier, a set of historical transaction data elements associated with the customer, and/or the like, such that the user profile includes data that may be relied upon by the apparatus 200 (e.g., personalization engine 208, or the like) to personalize a merchant identifier for a particular customer.

In some embodiments, the one or more payment accessibility parameters may be received in response to an automatic trigger event. An automatic trigger event may include a temporal trigger event, a circumstantial trigger event, and/or the like. A temporal trigger event may take place based on rules and/or configurations predefined by a user (e.g., a customer, merchant, or the like) or entity (e.g., a financial institution that is providing the personalized merchant identifier) that requires a computing device associated with the user (e.g., user device 106A, user device 106N, or the like) to transmit the one or more payment accessibility parameters within a particular time period or at a particular point in time. For example, the apparatus 200 (e.g., communications hardware 206) may periodically (e.g., monthly) transmit an electronic notification to user device 106A that prompts a customer to transmit one or more payment accessibility parameters.

A circumstantial trigger event may take place based on rules and/or configurations predefined by a user (e.g., a customer, or the like) or entity (e.g., a financial institution that is providing the personalized merchant identifier) that requires the transmission of one or more payment accessibility parameters from the user to the apparatus 200 (e.g., communications hardware 206). For example, communications hardware 206 may transmit an electronic notification that configures a circumstantial trigger that causes a computing device associated with a customer (e.g., user device 106N) to transmit one or more payment accessibility parameters to communications hardware 206 via a network (e.g., communications network 104, shown in FIG. 1) if the customer satisfies a predefined condition (e.g., if a user profile that includes a user's payment trends associated with a particular customer indicates that the particular customer is frequently using contactless payment methods while the user previously indicated in a historical one or more payment accessibility parameter to avoid merchants that only accept contactless payment options).

As shown by operation 308, the apparatus 200 includes means, such as memory 204, communications hardware 206, personalization engine 208, or the like, for comparing the one or more payment accessibility parameters to the set of merchant data elements to identify one or more compliant merchants. The one or more compliant merchants may be any merchant that complies with one or more of the rules and/or configurations described by the received one or more payment accessibility parameters. In some embodiments, a merchant may be considered a compliant merchant if the merchant satisfies a threshold number of payment accessibility parameters predefined by a user (e.g., a customer) or entity (e.g., a financial institution that is providing the personalized merchant identifier). For example, communications hardware 206 may receive a request from a computing device (e.g., user device 106A, or the like) associated with a customer that requests the compliant merchant to comply with all of the payment accessibility parameters previously defined by the user.

In some embodiments, the one or more received payment accessibility parameters in operation 306 may include information about a user's preferences for identifying the one or more compliant merchants. For example, the one or more payment accessibility parameters may describe that the user prefers the one or more compliant merchants to accept contactless payment options. As another example, the user profile may indicate that the user requires the one or more compliant merchants to be located in a particular geographic region (e.g., a city, a five-mile radius of a particular location, or the like). Since the one or more received payment accessibility parameters may include information about a user's preferences, the apparatus 200 may identify the user preferences in operation 306 and subsequently store the preferences in the user's user profile.

In some embodiments, personalization engine 208 may utilize one or more filtering operations to compare the one or more payment accessibility parameters to the set of merchant data elements to identify one or more compliant merchants. In this regard, personalization engine 208 may use one or more filtering techniques, such as collaborative filtering, content-based filtering, hybrid filtering, and/or the like. For example, personalization engine 208 may leverage a collaborative filtering model that determines one or more compliant merchants based on the one or more compliant merchants that were determined via previous comparisons for users with similar user profiles to the customer's user profile. In another example, personalization engine 208 may use a content based filtering model to determine one or more compliant merchants based on whether a merchant included in a set of merchant data elements complies with the one or more payment accessibility parameters. In some embodiments, personalization engine 208 may use a hybrid model that combines the results from the content based filtering model and the collaborative filtering model to determine one or more compliant merchants.

In some embodiments, personalization engine 208 may leverage a scoring model that may output a computed score for a particular merchant and/or a computed score for each particular merchant included in the set of merchant data elements. In some embodiments, the output score is indicative of the compliance of a particular merchant to a user's preferences (e.g., user preferences described in the one or more payment accessibility parameters). To this end, the one or more compliant merchants may be identified based on the satisfaction of a compliant merchant threshold predefined by an entity (e.g., a financial institution providing the personalized merchant identifier). For example, assume the score determined by the scoring model is a numerical value between 0 and 1. As a result, a score for a particular merchant may be required to satisfy a score threshold of 0.8 to be considered one of one or more compliant merchants.

In some embodiments, the computed score may be a numerical score (e.g., a score between 0 and 1), while in other embodiments the computed score may be converted into a categorical result (e.g., tier 1/tier 2/tier 3, green/yellow/red, or some other categorical classification). For example, a comparison of the one or more payment accessibility parameters to the set of merchant data elements may yield a high numerical score (e.g., 1.0) for a particular merchant indicating that the merchant data elements included in the set of merchant data elements for the particular merchant satisfies the one or more payment accessibility parameters and thus may be converted to a categorical result, such as “compliant merchant”.

In some embodiments, the scoring model may weight each merchant data element included in the set of merchant data elements for a particular merchant based on user preferences (e.g., included in a user profile) and/or based on predetermined weights set by the entity that provides the personalized merchant identifier. For example, assume that the one or more payment accessibility parameters describe a user preference for identifying one or more compliant merchants within a particular geographic region. To this end, the scoring model may update the weights of the scoring model to reflect the user preference for the particular geographic region by prioritizing the geographic location of the one or more compliant merchants.

In some embodiments, the scoring model may additionally account for projected satisfaction of a particular merchant's data elements with respect to the one or more payment accessibility parameters. For instance, assume a particular merchant operates year-round; however, the location of the merchant varies depending on the season. In this regard, personalization engine 208 may input the merchant data elements associated with the seasonal operation of the particular merchant, which may cause the scoring model to output a value and/or values representative of the seasonal nature of the particular merchant, such as a separate computed score for the winter months and the spring-fall months, an average of the two scores (e.g., an average of the score for the winter months and the spring-fall months), and/or the like.

In some embodiments, the personalization engine 208 may leverage a variety of models, such as unsupervised machine learning models, supervised machine learning models, time series analysis, or the like, to project whether a particular merchant may be compliant for a particular customer at a future time and subsequently input the calculated projection into the scoring model. For example, personalization engine 208 may leverage a logistic regression model trained from a historical set of merchant data elements and one or more previously identified compliant merchants to create a decision boundary based on the one or more payment accessibility parameters (e.g., a decision boundary that separates the payment type accepted, such as contactless payments or non-contactless payments for different days of the week, seasons, or the like). As such, the logistic regression model may receive particular input parameters, such as merchant data elements associated with a particular merchant included in the set of merchant data elements, the one or more payment accessibility parameters, and/or the like.

In some embodiments, the logistic regression model may calculate a compliant merchant probability using the learned decision boundary. The compliant merchant probability may be a numerical value (e.g., a number between 0 and 1). The compliant merchant probability may be indicative of the probability that a particular merchant may remain one of one or more compliant merchants for a particular one or more payment accessibility parameters. Said another way, the compliant merchant probability represents the probability that a merchant may be considered a one or more compliant merchant at a future time (e.g., a projection) based off of historical data (e.g., a historical set of merchant data elements associated with a particular merchant).

In some embodiments, the apparatus 200 (e.g., communications hardware 206) may receive event data from a computing device (e.g., user device 106A-106N, or the like) via a network (e.g., communications network 104, shown in FIG. 1) that indicates the occurrence of an event that may impact the one or more compliant merchants. For example, an event may be any event that impacts a merchant's ability to provide a particular service that was otherwise expected to be provided. Some example events may be a weather event (e.g., a blizzard, flash flood, or the like), a power outage, or the like. Personalization engine 208 may use optical character recognition (OCR), natural language processing (NLP), searching algorithms, and/or the like, to identify the event described in the event data. For example, personalization engine 208 may OCR any data in the received event data, if needed, and then search for an indicator of the event. As such, personalization engine 208 may search for terms, such as “weather”, “no road access”, “power outage”, and/or the like.

In some embodiments, personalization engine 208 may retrieve a set of event data rules from a local storage device (e.g., memory 204, storage device 110, or the like) that describe how to modify the comparisons to identify one or more compliant merchants with respect to the received event data. For example, assume received event data describes a power outage in the geographic region specified by the user in the received one or more payment accessibility parameters. As a result, personalization engine 208 may search the set of event data rules for an instruction that details how to r-evaluate and identify the one or more compliant merchants. To this end, the personalization engine 208 may use the instruction (e.g., input the instruction into the model that identified the one or more compliant merchants) to identify one or more compliant merchants with respect to received event data.

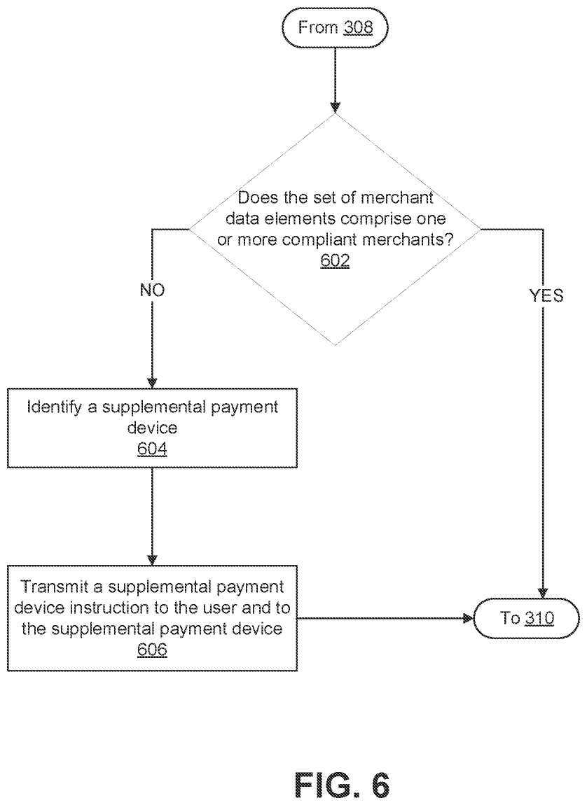

Turning now to FIG. 6, example operations are shown for performing an action when the set of merchant data elements does not comprise one or more compliant merchants.

As shown in operation 602, the apparatus 200 includes means, such as memory 204, notification circuitry 210, or the like, for determining if the set of one or more merchant data elements comprise one or more compliant merchants. In some embodiments, the set of one or more merchant data elements may not comprise one or more compliant merchants. To this end, the comparison performed in operation 308 by personalization engine 208 may not identify one or more compliant merchants any suitable reason. For example, the one or more compliant merchants may not be identified because the one or more payment accessibility parameters significantly narrow the possible one or more compliant merchants, the absence of one or more compliant merchants in a geographic region (e.g., food deserts), and/or the like.

In some embodiments, notification circuitry 210 may determine that the set of one or more merchant data elements does not comprise a compliant merchant by searching a local storage device (e.g., memory 204, storage device 110, or the like). For example, as mentioned above in relation to operation 308, if one or more compliant merchants are identified, personalization engine 208 may store the one or more compliant merchants in a local storage device and the procedure may advance to operation 310. However, if one or more compliant merchants are not stored in a local storage device, notification circuitry 210 may determine that the set of merchant data elements do not comprise one or more compliant merchants and the procedure may advance to operation 604.

As shown in operation 604, the apparatus 200 includes means, such as memory 204, communications hardware 206, personalization engine 208, or the like, for identifying a supplemental payment device. In some embodiments, a supplemental payment device may be any computing device that may process a transaction or help process a transaction that adheres to one or more payment accessibility parameters. For example, an ATM that can provide cash to a customer that requested in the one or more received payment accessibility parameters (e.g., described in operation 306) to pay in cash, a POS terminal for another merchant that may facilitate the transaction, and/or the like, may be a supplemental payment device.

In some embodiments, if personalization engine 208 cannot identify any compliant merchants, notification circuitry 210 may search a local storage device, such as memory 204 or storage device 110, to identify a supplemental payment device (e.g., supplemental payment device 108A, supplemental payment device 108N, or the like) that may be leveraged by the apparatus 200 and/or computing device associated with a user to facilitate a transaction with a noncompliant merchant. In some embodiments, personalization engine 208 may reference previously acquired and stored data that indicates the location of supplemental payment devices (e.g., supplemental payment device 108A, or the like). For example, assume a location was provided in the one or more payment accessibility parameters and personalization engine 208 did not identify any compliant merchants. As a result, personalization engine 208 may then search a storage device, such as memory 204, storage device 110, or the like, for a supplemental payment device within a predetermined radius (e.g., predetermined by the entity that is providing the personalized merchant identifier, the customer, and/or the like) around the geographic location specified in the one or more payment accessibility parameters.

In some embodiments, personalization engine 208 may use an indication of near-range wireless signals to identify a supplemental payment device. For example, assume communication hardware 206 received one or more payment accessibility parameters from a user that included a request to locate one or more compliant merchants within a radius (e.g., a predefined radius defined by the user) around the user. As a result, communications hardware 206 may then transmit a request to the user device that transmitted the one or more payment accessibility parameters to search for near-range wireless signals that are indicative of a supplemental payment device. Alternatively, the user device may be configured to search for a supplemental payment device via near-range wireless signals while transmitting the one or more payment accessibility parameters and thus communications hardware 206 may receive the indication of a supplemental payment device in the initially received one or more payment accessibility parameters (received in operation 306).

As shown in operation 606, the apparatus 200 includes means, such as memory 204, communications hardware 206, notification circuitry 210, or the like, for transmitting a supplemental payment device instruction to the user and to the supplemental payment device. To this end, personalization engine 208 may leverage communications hardware 206 to transmit an electronic message from a computing device associated with the user (e.g., user device 106A, or the like) via a network (e.g., communications network 104, shown in FIG. 1) to a computing device (e.g., supplemental payment device 108A, or the like) that requested an immediate response from the apparatus 200 that describes instructions for using the identified supplemental payment device (e.g., supplemental payment device 108A, or the like).

In some embodiments, electronic instructions (e.g., a supplemental payment device instruction) that describe how to use the identified supplemental payment device may include directions to the supplemental payment device, how to operate the supplemental payment device, authentication information, and/or the like. In addition, communications hardware 206 may transmit an instruction to the identified supplemental payment device that notifies and/or configures the supplemental payment device for the particular user thereby allowing the particular user to utilize the supplemental payment device to complete a transaction with another merchant, withdraw cash, and/or the like.

Returning to FIG. 3, finally, as shown by operation 310, the apparatus 200 includes means, such as memory 204, communications hardware 206, notification circuitry 210, or the like, for performing an action. In some embodiments, the action refers to a real-world operation. In some embodiments, the action may be any operation performed in response to identifying one or more compliant merchants. In some embodiments, the action to be performed may be specified in the user profile and/or predefined by a customer in the received one or more payment accessibility parameters (e.g., a customer may request that a particular action is performed). For example, notification circuitry 210 may retrieve an available action set from the user profile stored in a local storage device (e.g., memory 204, storage device 110, or the like). The available action set may include a one or more actions that may be performed if a compliant merchant is identified.

In some embodiments, the one or more actions may include the apparatus 200 (e.g., notification circuitry 210) generating a personalized payment graphic. The personalized payment graphic may illustrate the one or more compliant merchants identified in operation 308. In some embodiments, the personalized payment graphic may be personalized based on user preferences included in a user profile that may be stored in a local storage device, such as memory 204, storage device 110, or the like, and may be associated with a particular user's user profile. For example, a user profile may indicate particular parameters and/or data to be displayed and/or withheld from the personalized payment graphic. Alternatively, in the absence of user preferences associated with the personalized payment graphic, memory 204 and/or storage device 110 may store instructions for a default personalized payment graphic.

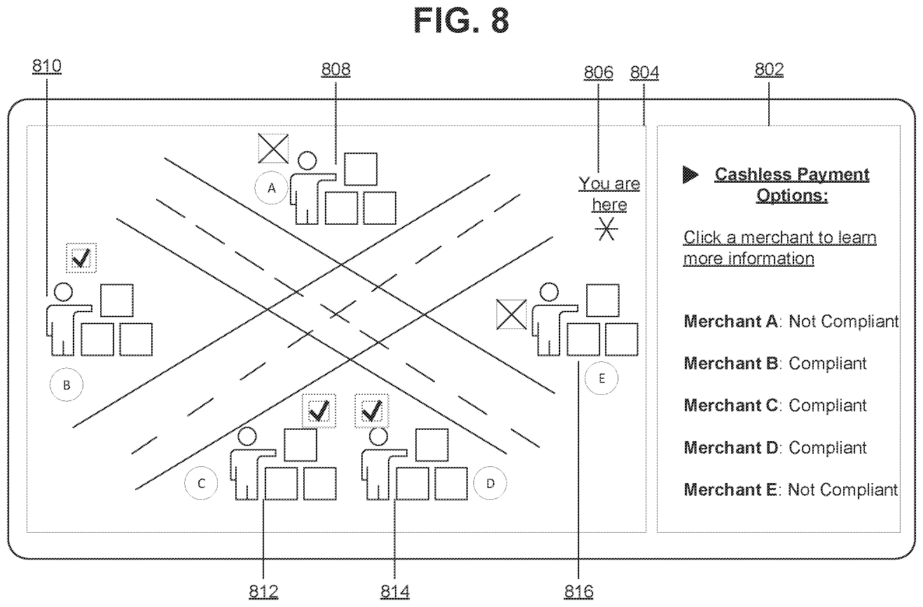

In some embodiments, notification circuitry 210 may cause presentation of the personalized payment graphic to the user. For example, notification circuitry 210 may leverage communications hardware 206 to transmit the personalized payment graphic to a computing device associated with a user (e.g., user device 106A, or the like) via a network (e.g., communications network 104, shown in FIG. 1). An example presentation of the personalized payment graphic illustrated on a computing device associated with a user is illustrated below in relation to FIG. 8.

In some embodiments, operation 310 may be performed in accordance with the operations described by FIG. 7. Turning now to FIG. 7, example operations are shown for performing an action if a geofence is violated.

As shown by operation 702, the apparatus 200 may include means, such as memory 204, communications hardware 206, or the like, for receiving a geofence notification. A geofence notification may be an electronic message received from a computing device associated with a user (e.g., user device 106A, or the like) via a network (e.g., communications network 104, shown in FIG. 1). In some embodiments, the geofence notification may include data that describes a particular user (e.g., a unique user ID, device ID, or the like), a time stamp of when the user violated the geofence, the location of the user, whether the geofence violation was an entry or an exit of the geofence, and/or the like.

In some embodiments, the apparatus 200 (e.g., notification circuitry 210) may continuously or periodically monitor the location of a computing device associated with a user (e.g., user device 106A, or the like). The notification circuitry 210 may passively monitor (e.g., no interaction with the user) the computing device associated with a user or actively monitor the computing device associated with the user (e.g., prompting the user to transmit their location from the computing device). If notification circuitry 210 identifies through monitoring the location of a computing device associated with the user that the computing device violated a geofence, the procedure may automatically advance to operation 404.

Additionally or alternatively, the notification circuitry 210 may leverage communications hardware 206 to transmit an electronic notification to the computing device (e.g., user device 106A, or the like) that initially violated the geofence. The electronic notification may instruct the computing device to transmit, if needed, any necessary information that the apparatus 200 may require to proceed to operation 704, such as location data, entry or exit data, time stamp data, a user ID, device ID, and/or the like. For example, notification circuitry 210 may utilize one or more techniques, such as optical character recognition (OCR), natural language processing (NLP), searching algorithms, or the like, to identify the location of a particular user. For instance, notification circuitry 210 may OCR any data in the geofence notification, if needed, and then search for an indicator of the location of the computing device, such as the terms “latitude”, “longitude”, “location”, and/or the like, which may act as an identifier to identify the location of the computing device associated with the user.

As shown by operation 704, the apparatus 200 includes means, such as memory 204, communications hardware 206, personalization engine 208, or the like, for retrieving a user profile. The user profile may be the same user profile that is generated and/or referenced in operation 306. In some embodiments the user profile may include geofence parameters that are predefined by the user associated with the user profile and may determine how the apparatus 200 (e.g., communications hardware 206, notification circuitry 210, or the like) may respond in response to identifying that the user violated a geofence. As such, personalization engine 208 may use one or more techniques, such as optical character recognition (OCR), natural language processing (NLP), searching algorithms, or the like, to identify a user associated with the received geofence notification. For example, personalization engine 208 may OCR any data in the received geofence notification, if needed, and then search for an indicator of the user, such as the terms “user ID”, “user name”, or the like.

In some embodiments, personalization engine 208 may search a database stored in a local storage device, such as memory 204, storage device 110, and/or the like, for the user profile. For example, a database storing the user profiles may store the user profiles and the user identifier (e.g., a user ID) in the form of key-value pairs, where the key portion specifies the user ID and the value portion specifies the user profile. Thus, personalization engine 208 may search for a particular user ID, which may be a key that is associated with a particular user profile.

Finally, as shown by operation 706, the apparatus 200 includes means, such as memory 204, communications hardware 206, or the like, for transmitting a geofence personalized payment notification. The geofence personalized payment notification may be an electronic notification generated by the apparatus 200 (e.g., notification circuitry 210, or the like) and transmitted to a computing device (e.g., user device 106A, or the like) associated with the user that violated a geofence. In some embodiments, the geofence personalized payment notification may include particular data associated with the violated geofence, such as one or more compliant merchants (e.g., compliant merchants determined based on one or more payment accessibility parameters included in a user's profile). In addition, the user profile may include data that describes user preferences for the geofence personalized payment notification.

In some embodiments, the geofence personalized payment notification may include data about one or more compliant merchants within the predefined geofence. For example, assume notification circuitry 210 searched the user profile associated with the computing device that violated a geofence and identified that the user profile describes identifying one or more compliant merchants that satisfy requirements outlined in the user profile. As a result, notification circuitry 210 may generate a geofence personalized payment notification that includes the location data, merchant name, and/or the like, of one or more compliant merchants. In addition, the geofence personalized payment notification may include a personalized payment graphic similar to the personalized payment graphic presented to the user via a computing device associated with the user described above in relation to operation 310.

In some embodiments, notification circuitry 210 may leverage communications hardware 206 to transmit the geofence personalized payment notification to the computing device (e.g., user device 106A, or the like) associated with the user that violated the geofence. For example, communications hardware 206 may transmit the geofence personalized payment notification to user device 106A via a network (e.g., communications network 104, shown in FIG. 1).

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example Graphical User Interface

Turning to FIG. 8, a graphical user interface (GUI) is provided that illustrates an example presentation of a personalized payment graphic on a computing device (e.g., user device 106A, or the like). As noted previously in operation 310 and 706, a computing device associated with a user may present a personalized payment graphic to the user. In such an embodiment, the GUI shown in FIG. 8 may be displayed to a user by the user device 106A-106N associated with the user.

Window 802 may be automatically displayed on the computing device associated with a user (e.g., user device 106A, or the like). Alternatively, window 802 may be displayed in response to the user (e.g., a customer) interacting with the cashless payment options title. Window 802 may include a list of merchants and their respective status that indicates whether the merchant was identified as one of one or more compliant merchants. A user may interact with window 802 by hovering a cursor over a particular merchant in window 802, clicking a particular merchant, and/or the like, to reveal additional merchant data, such as the location of the merchant, accepted payment types, or the like. In addition, the graphic user interface may include a window 804. Window 804 may depict a map that illustrates the user's current location 506 with respect to the identified merchants located in window 802. Each merchant may include an indicator that displays whether a particular merchant is classified as one of one or more compliant merchants (e.g., a check mark for a compliant merchant and an ‘x’ for a noncompliant merchant). As such, merchant 808, merchant 810, merchant 812, merchant 814, and merchant 816 have a box with a checkmark or a ‘x’ that indicates whether the merchant is one of one or more compliant merchants. In addition, each merchant in window 804 may include a label that corresponds to the merchant label in window 802. To this end merchant 808 is labeled by the letter ‘A’, merchant 810 is labeled by the letter ‘B’, merchant 812 is labeled by the letter ‘C’, merchant 814 is labeled by the letter ‘D’, and merchant 816 is labeled by the letter ‘E’.

### CONCLUSION

As described above, example embodiments provide methods and apparatuses that enable improved personalization for identifying merchants for customers. Example embodiments thus provide tools that overcome the problems faced by traditional personalization techniques, such as accurate trend identification for a variety of trends. By avoiding the use of traditional personalization techniques that provide static and/or slowly changing information, or that require manual interaction with merchants and customers, example embodiments thus increase efficiency and reliability of individualized personalization, while also eliminating the possibility of personalizing a customer experience based off aged data. Moreover, example embodiments described herein avoid the difficulties associated with continuously updating the set of merchant data elements for a particular merchant. Finally, by automating the detection of trends in real-time as new transaction data elements are received, which has historically required human analysis, the speed and consistency of the evaluations performed by example embodiments unlocks many potential new functions that have historically not been available, such as the ability to conduct near-real-time dispute resolution when conclusions drawn regarding records challenges assumptions that have previously been made regarding those records.

As these examples all illustrate, example embodiments contemplated herein provide technical solutions that solve real-world problems faced while providing sophisticated personalization for identifying merchants for customers. And while personalizing the identification of merchants for customers has been an issue for decades, the recently exploding amount of payment types made available by recently emerging technology today has made this problem significantly more acute, as the demand for sophisticated personalization has grown significantly even while the complexity of different types of payment options has itself increased. Example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for personalizing a merchant identifier, the method comprising:
receiving, by communications hardware, a set of transaction data elements, wherein the set of transaction data elements includes an indication of a payment type or a merchant;
deriving, by a personalization engine, a set of merchant data elements from the set of transaction data elements;
receiving, by the communications hardware, one or more payment accessibility parameters from a user;
comparing, by the personalization engine, the one or more payment accessibility parameters to the set of merchant data elements to identify one or more compliant merchants, wherein the one or more compliant merchants comply with the one or more payment accessibility parameters; and
performing, by a notification circuitry and based on the one or more compliant merchants, an action.

2. The method of claim 1, wherein deriving the set of merchant data elements comprises:
identifying, by the personalization engine, a payment trend, wherein the payment trend describes a particular merchant associated with the payment type.

3. The method of claim 2, wherein in an instance in which the payment trend indicates a payment deviation:
transmitting, by the communications hardware, a payment trend confirmation request, wherein the payment trend confirmation request confirms or rejects the payment deviation; and
receiving, by the communications hardware, the payment trend confirmation request, wherein the payment trend confirmation request is used to determine the payment trend.

4. The method of claim 2, wherein identifying the payment trend comprises:
determining, by the personalization engine and based on the set of merchant data elements, a merchant trend parameter; and
applying, by the personalization engine, a trend identification model, wherein the trend identification model uses the merchant trend parameter to identify the payment trend.

5. The method of claim 1, wherein in an instance in which the set of merchant data elements does not comprise the one or more compliant merchants:
identifying, by the personalization engine, a supplemental payment device, wherein the supplemental payment device performs a transaction.

6. The method of claim 5, wherein performing the transaction comprises:
transmitting, by the communications hardware, a supplemental payment device instruction to the user and to the supplemental payment device.

7. The method of claim 1, further comprising:
generating, by the notification circuitry and based on the set of merchant data elements, a geofence, wherein one or more merchants are included in the geofence.

8. The method of claim 7, further comprising:
in an instance in which the geofence is violated:
receiving, by the communications hardware, a geofence notification, wherein the geofence notification indicates the user;
retrieving, by the personalization engine, a user profile, wherein the user profile is associated with the user; and
transmitting, by the communications hardware and based on the user profile, a geofence personalized payment notification, wherein performing the action comprises transmitting the geofence personalized payment notification.

9. The method of claim 1, wherein performing the action comprises:
generating, by the notification circuitry, a personalized payment graphic, wherein the personalized payment graphic illustrates the one or more compliant merchants; and
causing, by the notification circuitry, presentation of the personalized payment graphic to the user.

10. The method of claim 1, wherein identifying the one or more compliant merchants comprises:
receiving, by the communications hardware, event data, wherein the event data alters the one or more compliant merchants.

11. An apparatus for personalizing a merchant identifier, the apparatus comprising:
communications hardware configured to receive a set of transaction data elements, wherein the set of transaction data elements includes an indication of a payment type or a merchant;
a personalization engine configured to derive a set of merchant data elements from the set of transaction data elements;
the communications hardware further configured to receive one or more payment accessibility parameters from a user;
the personalization engine further configured to compare the one or more payment accessibility parameters to the set of merchant data elements to identify one or more compliant merchants, wherein the one or more compliant merchants comply with the one or more payment accessibility parameters; and
a notification circuitry configured to perform an action based on the one or more compliant merchants.

12. The apparatus of claim 11, wherein the personalization engine is further configured to:
identify a payment trend, wherein the payment trend describes a particular merchant associated with the payment type.

13. The apparatus of claim 12, wherein in an instance in which the payment trend indicates a payment deviation:
the communications hardware is further configured to:
transmit a payment trend confirmation request, wherein the payment trend confirmation request confirms or rejects the payment deviation; and
receive the payment trend confirmation request, wherein the payment trend confirmation request is used to determine the payment trend.

14. The apparatus of claim 12, wherein the personalization engine is further configured to:
determine, based on the set of merchant data elements, a merchant trend parameter; and
apply a trend identification model, wherein the trend identification model uses the merchant trend parameter to identify the payment trend.

15. The apparatus of claim 11, wherein the notification circuitry is further configured to:
generate a personalized payment graphic, wherein the personalized payment graphic illustrates the one or more compliant merchants; and
cause presentation of the personalized payment graphic to the user.

16. A computer program product for personalizing a merchant identifier, the computer program product comprising a non-transitory computer-readable storage medium storing instructions that, when executed by an apparatus, cause the apparatus to:
receive a set of transaction data elements, wherein the set of transaction data elements includes an indication of a payment type or a merchant;
derive a set of merchant data elements from the set of transaction data elements;
receive one or more payment accessibility parameters from a user;
compare the one or more payment accessibility parameters to the set of merchant data elements to identify one or more compliant merchants, wherein the one or more compliant merchants comply with the one or more payment accessibility parameters; and
perform, based on the one or more compliant merchants, an action.

17. The computer program product of claim 16, wherein the instructions, when executed by the apparatus, further cause the apparatus to:
identify a payment trend, wherein the payment trend describes a particular merchant associated with the payment type.

18. The computer program product of claim 17, wherein in an instance in which the payment trend indicates a payment deviation, wherein the instructions, when executed by the apparatus, further cause the apparatus to:
transmit a payment trend confirmation request, wherein the payment trend confirmation request confirms or rejects the payment deviation; and
receive the payment trend confirmation request, wherein the payment trend confirmation request is used to determine the payment trend.

19. The computer program product of claim 17, wherein the instructions, when executed by the apparatus, further cause the apparatus to:
determine, based on the set of merchant data elements, a merchant trend parameter; and
apply a trend identification model, wherein the trend identification model uses the merchant trend parameter to identify the payment trend.

20. The computer program product of claim 16, wherein the instructions, when executed by the apparatus, further cause the apparatus to:
generate a personalized payment graphic, wherein the personalized payment graphic illustrates the one or more compliant merchants; and
cause presentation of the personalized payment graphic to the user.
